(19) United States
(12) Patent Application Publication
(10) Pub. No.: US 2019/0266970 A1
(43) Pub. Date: Aug. 29, 2019

(54) MULTI-LAYER DISPLAY SYSTEMS WITH ROTATED PIXELS

(71) Applicant: PURE DEPTH, INC., Redwood City, CA (US)

(72) Inventor: John NEWTON, Auckland (NZ)

(21) Appl. No.: 16/281,764

(22) Filed: Feb. 21, 2019

Related U.S. Application Data
(60) Provisional application No. 62/635,105, filed on Feb. 26, 2018.

(51) Int. Cl. G09G 3/36; G02F 1/1347; G02F 1/1335; G02F 1/1362; G02F 1/1333

(52) U.S. Cl. CPC G09G 3/3666; G02F 1/13471; G02F 2001/133331; G02F 1/136286; G02F 1/133308; G02F 1/133514

(57) ABSTRACT

An instrument panel may include a multi-layer display including a first and second display panels arranged in a substantially parallel manner, the second display panel overlapping the first display panel. The first display panel may include a first array of pixels and a first addressing matrix for driving the first array of pixels. The second display panel may include a second array of pixels that are rotated with reference to the first array of pixels and a second addressing matrix for driving the second array of pixels. The first addressing matrix and the second addressing may be arranged in the same direction with respect to each other. A backlight may be configured to provide light to the first display panel and the second display panel. A processing system may be configured to display content on the first display panel and content on the second display panel.

### CROSS REFERENCE TO RELATED APPLICATIONS

This patent application claims priority to and the benefit of U.S. Provisional Application No. 62/635,105, filed on Feb. 26, 2018, which is hereby incorporated herein by reference in its entirety.

Displays described herein may be used in any multi-layer display (MLD) systems, including but not limited to in any of the multi-display systems described in any of U.S. Pat. No. 6,906,762, or U.S. patent application Ser. No. 14/986,158, filed on Dec. 31, 2015; Ser. No. 14/855,822, filed on Sep. 16, 2015; Ser. No. 14/632,999, filed on Feb. 26, 2015; Ser. No. 15/338,777, filed on Oct. 31, 2016; Ser. No. 15/283,525, filed on Oct. 3, 2016; Ser. No. 15/283,621, filed on Oct. 3, 2016; Ser. No. 15/281,381, filed on Sep. 30, 2016; Ser. No. 15/409,711, filed on Jan. 19, 2017; Ser. No. 15/393,297, filed on Dec. 29, 2016; Ser. No. 15/378,466, filed on Dec. 14, 2016; Ser. No. 15/359,732, filed on Nov. 23, 2016; Ser. No. 15/391,903 filed on Dec. 28, 2016, all of which are hereby incorporated herein by reference in their entireties.

### FIELD OF THE INVENTION

This invention relates to a multi-display system (e.g., a display including multiple display panels/display layers), where at least first and second displays (e.g., display panels or display layers) are arranged substantially parallel to each other in order to display three-dimensional (3D) features to a viewer(s). Thus, this invention relates generally to displays and, more particularly, to display systems and methods for displaying three-dimensional features.

### BACKGROUND

Traditionally, displays present information in two dimensions. Images displayed by such displays are planar images that lack depth information. Because people observe the world in three-dimensions, there have been efforts to provide displays that can display objects in three-dimensions. For example, stereo displays convey depth information by displaying offset images that are displayed separately to the left and right eye. When an observer views these planar images they are combined in the brain to give a perception of depth. However, such systems are complex and require increased resolution and processor computation power to provide a realistic perception of the displayed objects.

Multi-component displays including multiple display screens in a stacked arrangement have been developed to display real depth. Each display screen may display its own image to provide visual depth due to the physical displacement of the display screens. For example, multi-display systems are disclosed in U.S. Patent Publication Nos. 2015/0323805 and 2016/0012630, the disclosures of which are both hereby incorporated herein by reference.

When first and second displays or display layers are conventionally stacked on each other in a multi-display system, moire interference may occur. The moire interference is caused by interactions between the color filters within the layers when light is projected onto a viewer's retina. For example, when green color filters overlap, light is transmitted making for a comparative bright patch. When a green filter overlaps a red filter, not as much light will be transmitted making for a dark region. Since the rear and front displays or display layers have slightly different sizes when projected onto the retina, the pixels will slowly change from being in phase to out of phase. This has the effect of producing dark and bright bands otherwise known as moire interference.

### SUMMARY

Exemplary embodiments of this disclosure provide a display system a display system that can display content on different display screens of a multi-layer display provided in a stacked arrangement. The multi-layer display system may include a plurality of display panels arranged in an overlapping manner, a backlight configured to provide light to the plurality of display panels, and a processing system. Each of the display panels may include an array of pixels, with pixels in at least one display panel being rotated with reference to pixels in another display panel, and addressing matrix in each display panel for the driving the array of pixels being arranged in an overlapping manner.

According to one exemplary embodiment, an instrument panel comprises a multi-layer display including a first display panel and a second display panel arranged in a substantially parallel manner, the second display panel overlapping the first display panel, the first display panel including a first array of pixels and a first addressing matrix for driving the first array of pixels, the second display panel including a second array of pixels that are rotated with reference to the first array of pixels and a second addressing matrix for driving the second array of pixels, the first addressing matrix and the second addressing being arranged in the same direction with respect to each other; a backlight configured to provide light to the first display panel and the second display panel; and a processing system comprising at least one processor and memory, the processing system configured to simultaneously display content on the first display panel and content on the second display panel.

In another exemplary embodiment, colour filters in the first display panel are rotated with reference to colour filter in the second display panel.

In another exemplary embodiment, electrodes of the first array of pixels and/or the second array of pixels are transparent electrodes.

In another exemplary embodiment, electrodes of the first array of pixels or the second array of pixels are provided on the same glass layer as pixel transistors and the respective first addressing matrix or second addressing matrix.

In another exemplary embodiment, the row and column track placement of the first addressing matrix and the second addressing matrix is in a rectilinear format with one row line per pixel and one column line per subpixel.

In another exemplary embodiment, a multi-layered display comprising: a first screen configured to display a first image and having a first pixel alignment and a first addressing matrix alignment for driving the pixels in the first screen; and a second screen configured to display a second image and having a second pixel alignment and a second addressing matrix alignment for driving the pixels in the second screen, wherein the first screen is in front of the second screen, wherein the second pixel alignment is 45 degrees with respect to the first pixel alignment and the first addressing matrix alignment corresponds to the second addressing matrix alignment.

In another exemplary embodiment, the first screen is a selectively transparent foreground screen capable of displaying a foreground image and the second screen is a background screen capable of displaying a background image.

In another exemplary embodiment, the first addressing matrix substantially overlaps the second addressing matrix.

In another exemplary embodiment, pixel electrodes in the first screen and the second screen are transparent electrodes.

In another exemplary embodiment, the row and column track placement of the first addressing matrix and the second addressing matrix is in a rectilinear format with one row line per pixel and one column line per subpixel.

In another exemplary embodiment, a multi-layered display comprising: a first screen configured to display first content and including a first addressing matrix alignment for driving pixels in the first screen; and a second screen, arranged in a substantially parallel manner with the first screen, configured to display second content, and including a second addressing matrix alignment for driving pixels in the second screen, wherein colour filters of sub-pixels in the first screen are rotated with reference to colour filters of sub-pixels in the second screen, and row and column tracks of the first addressing matrix and the second addressing matrix are arranged in a rectilinear configuration.

In another exemplary embodiment, the first screen is a touch sensitive display, and further includes a processing system configured to detect whether a touch input is performed to a portion of the first screen displaying the content.

In another exemplary embodiment, pixel electrodes of the first screen and/or pixel electrodes of the second screen are transparent electrodes.

In another exemplary embodiment, pixel electrodes of the first screen or second screen are provided on the same glass layer as sub-pixel transistors and the respective first addressing matrix or second addressing matrix.

In another exemplary embodiment, the colour filters of sub-pixels in the first screen are rotated 45 degrees with reference to colour filters of sub-pixels in the second screen.

In another exemplary embodiment, the row and column tracks of the first addressing matrix overlap the row and column tracks of the second addressing matrix.

In another exemplary embodiment, an instrument panel comprising; a multi-layer display including a front display panel and a rear display panel arranged in a substantially parallel manner, the front display panel overlapping the rear display panel, the front display panel and the rear display panel including an array of pixels, each pixel including red (R), green (G), and blue (B) sub-pixels, wherein the red (R), green (G), and blue (B) sub-pixels of the front display panel are rotated with reference to the red (R), green (G), and blue (B) sub-pixels of the rear display panel; the multi-layer display further comprising a pair of crossed polarized layers, a first polarized layer of the pair of crossed polarized layers provided in front of and adjacent to the front display panel and a second polarized layer of the pair of crossed polarized layers provided behind and adjacent to the rear display panel; a first data driver configured to control the red (R), green (G), and blue (B) sub-pixels of the front display panel and a first gate driver configured to provide scan pulses to the red (R), green (G), and blue (B) sub-pixels of the front display panel, wherein the first data driver and the first gate driver transmit signals via a first set of row and column tracks; a second data driver configured to control the red (R), green (G), and blue (B) sub-pixels of the rear display panel and a second gate driver configured to provide scan pulses to the red (R), green (G), and blue (B) sub-pixels of the rear display panel, wherein the second data driver and the second gate driver transmit signals via a second set of row and column tracks that are arranged in a substantially parallel manner to the first set of row and column tracks; and a backlight configured to provide light to the front display panel and the rear display panel of the multi-layer display; and a processing system comprising at least one processor and memory, the processing system configured to: control the front display panel to display first content; and control the rear display panel to display second content.

In another exemplary embodiment, the first set of row and column tracks and the second set of row and column tracks are arranged in a rectilinear configuration with one row line per pixel and one column line per sub-pixel.

In another exemplary embodiment, the red (R), green (G), and blue (B) sub-pixels of the front display panel are rotated 45 degrees with reference to the red (R), green (G), and blue (B) sub-pixels of the rear display panel.

In another exemplary embodiment, wherein sub-pixel electrodes of the front display panel and the rear display panel are transparent electrodes.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

So that features of the present invention can be understood, a number of drawings are described below. It is to be noted, however, that the appended drawings illustrate only particular embodiments of the invention and are therefore not to be considered limiting of its scope, for the invention may encompass other equally effective embodiments.

FIG. 1 illustrates a multi-layer display system according to an embodiment of the present disclosure.

FIGS. 2A-C illustrate an arrangement in an MLD system which experiences moire interference.

FIGS. 3A and 3B illustrate an exemplary layout of pixels with both the addressing matrix and pixel electrodes rotated such that they are provided at the same angle.

FIGS. 4A and 4B illustrate an exemplary embodiment with the subpixels addressing matrix which is rotated with respect to the pixel electrodes.

FIG. 5 illustrates an exemplary embodiment of control system for a display including RGB sub-pixel configuration.

FIG. 6 illustrates an exemplary processing system upon which various embodiments of the present disclosure(s) may be implemented.

### DETAILED DESCRIPTION

Certain example embodiments of this application provide solution(s) that make moiré interference in MLD systems vanish or substantially vanish. Color moiré interference problem is caused by the pattern regularity of both liquid crystal display (LCD) color filter arrays as, for example, RGB pixels are aligned into RGB columns in both displays of a MLD system. MLDs according to example embodiments of this invention may be used, for example, as displays in vehicle dashes in order to provide 3D images (e.g., for speedometers, vehicle gauges, vehicle navigation displays, etc.). One or more of the example embodiments disclosed in this application may be used with other display systems and/or techniques that are designed to reduce moire interference. For example, embodiments of this disclosure may be used together with example MLD adapted to reduce moire interference described in U.S. Pat. No. 6,906,762 and/or U.S. application Ser. No. 15/409,711 filed on Jan. 19, 2017, each of which is incorporated by reference in its entirety.

Embodiments of this disclosure provide for reducing the moiré interference while providing for a simple system that reduces design complexity, cost, and improved performance. As will be discussed in more detail below, the moiré interference may be reduced by rotating pixels of one display with respect to pixels of the other display while maintaining the same orientation of the addressing matrix in both displays.

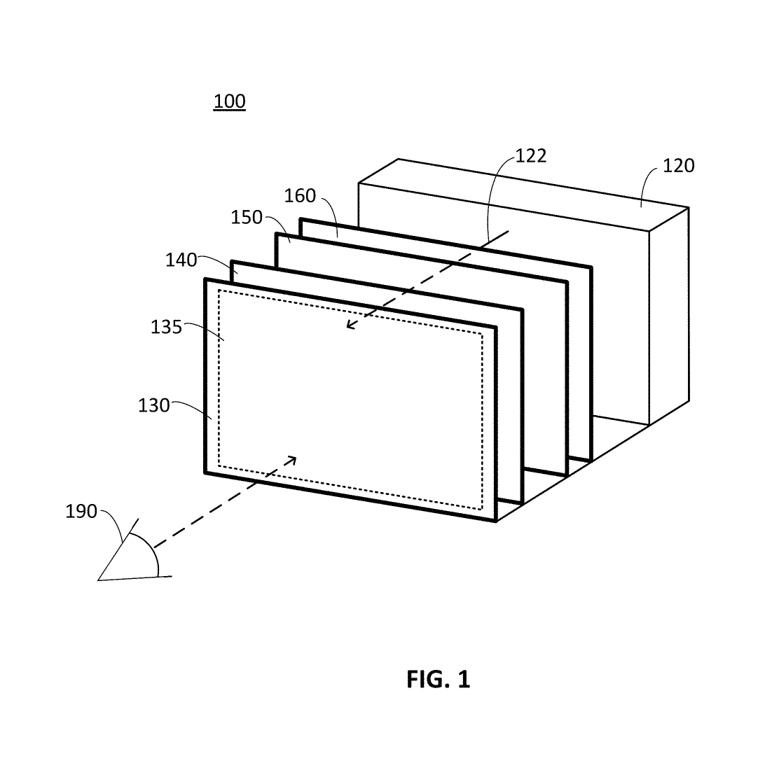

FIG. 1 illustrates a multi-layer display system 100 according to an embodiment of the present disclosure. The display system 100 may include a light source 120 (e.g., rear mounted light source, side mounted light source, optionally with a light guide), and a plurality of display screens 130-160. Each of the display screens 130-160 may include multi-domain liquid crystal display cells. One or more of the display screens 130-160 may include a black mask defining the visible parts of the liquid crystal display cells. One or more of the display screens 130-160 may be provided without a black mask.

The display screens 130-160 may be disposed substantially parallel or parallel to each other and/or a surface (e.g., light guide) of the light source 120 in an overlapping manner In one embodiment, the light source 120 and the display screens 130-160 may be disposed in a common housing. The display apparatus 100 may be provided in an instrument panel installed in a dashboard of a vehicle. The instrument panel may be configured to display information to an occupant of the vehicle via one or more displays 130-160 and/or one or more mechanical indicators provided in the instrument panel. One or more of the mechanical indicators may be disposed between the displays 130-160. The displayed information using the displays 130-160 and/or the mechanical indicators may include vehicle speed, engine coolant temperature, oil pressure, fuel level, charge level, and navigation information, but is not so limited. It should be appreciated that the elements illustrated in the figures are not drawn to scale, and thus, may comprise different shapes, sizes, etc. in other embodiments.

The light source 120 may be configured to provide illumination for the display system 100. The light source 120 may provide substantially collimated light 122 that is transmitted through the display screens 130-160.

Optionally, the light source 120 may provide highly collimated light using high brightness LED's that provide for a near point source. The LED point sources may include pre-collimating optics providing a sharply defined and/or evenly illuminated reflection from their emission areas. The light source 120 may include reflective collimated surfaces such as parabolic mirrors and/or parabolic concentrators. In one embodiment, the light source 120 may include refractive surfaces such as convex lenses in front of the point source. However, the LEDs may be edge mounted and direct light through a light guide which in turn directs the light toward the display panels in certain example embodiments. The light source 120 may comprise a plurality of light sources, with each light source providing backlight to a different region of the display screens 130-160. In one embodiment, the light source 120 may be configured to individual provide and control light for each pixels of a panel in front of the light source 120.

Each of the display panels/screens 130-160 may include a liquid crystal display (LCD) matrix. Alternatively, one or more of the display screens 130-160 may include organic light emitting diode (OLED) displays, transparent light emitting diode (TOLED) displays, cathode ray tube (CRT) displays, field emission displays (FEDs), field sequential display or projection displays. In one embodiment, the display panels 130-160 may be combinations of either full color RGB, RGBW or monochrome panels. Accordingly, one or more of the display panels may be RGB panels, one or more of the display panels may be RGBW panels and/or one or more of the display panels may be monochrome panels. One or more of the display panels may include passive white (W) sub-pixels. The display screens 130-160 are not limited to the listed display technologies and may include other display technologies that allow for the projection of light. In one embodiment, the light may be provided by a projection type system including a light source and one or more lenses and/or a transmissive or reflective LCD matrix. The display screens 130-160 may include a multi-layer display unit including multiple stacked or overlapped display layers each configured to render display elements thereon for viewing through the uppermost display layer.

In one embodiment, each of the display screens 130-160 may be approximately the same size and have a planar surface that is parallel or substantially parallel to one another. In other embodiments, the displays screens may be of difference size (e.g., a front display may be smaller than one or more of the displays it overlaps). In another embodiment, one or more of the display screens 130-160 may have a curved surface. In one embodiment, one or more of the display screens 130-160 may be displaced from the other display screens such that a portion of the display screen is not overlapped and/or is not overlapping another display screen.

Each of the display screens 130-160 may be displaced an equal distance from each other in example embodiments. In another embodiment, the display screens 130-160 may be provided at different distances from each other. For example, a second display screen 140 may be displaced from the first display screen 130 a first distance, and a third display screen 150 may be displaced from the second display screen 140 a second distance that is greater than the first distance. The fourth display screen 160 may be displaced from the third display screen 150 a third distance that is equal to the first distance, equal to the second distance, or different from the first and second distances.

The display screens 130-160 may be configured to display graphical information for viewing by the observer 190. The viewer/observer 190 may be, for example, a human operator or passenger of a vehicle, or an electrical and/or mechanical optical reception device (e.g., a still image, a moving-image camera, etc.). Graphical information may include visual display content (e.g., objects and/or texts). The display screens 130-160 may be controlled to display content simultaneously on different display screens 130-160. At least a portion of content displayed on one of the display screens 130-160 may overlap content displayed on another one of the display screens 130-160.

In one embodiment, the graphical information may include displaying images or a sequence of images to provide video or animations. In one embodiment, displaying the graphical information may include moving objects and/or text across the screen or changing or providing animations to the objects and/or text. The animations may include changing the color, shape and/or size of the objects or text. In one embodiment, displayed objects and/or text may be moved between the display screens 130-160. In moving the content between the display screens 130-160, content displayed on one of the screen may be divided into segments, the segments assigned a position in a time sequence, and the segments may be animated by varying optical properties of each segment on each of the display screens at a time specified by the time sequence. In some embodiments, content may be moved over more than two screens. The distances between the display screens 130-160 may be set to obtain a desired depth perception between features displayed on the display screens 130-160.

In one embodiment, a position of one or more of the display screens 130-160 may be adjustable by an observer 190 in response to an input. Thus, an observer 190 may be able to adjust the three dimension depth of the displayed objects due to the displacement of the display screens 130-160. A processing system may be configured to adjust the displayed graphics and gradients associated with the graphics in accordance with the adjustment.

Each of the display screens 130-160 may be configured to receive data and display, based on the data, a different image on each of the display screens 130-160 simultaneously. Because the images are separated by a physical separation due to the separation of the display screens 130-160, each image is provided at a different focal plane and depth is perceived by the observer 190 in the displayed images. The images may include graphics in different portions of the respective display screen.

While not illustrated in FIG. 1, the display system 100 may include one or more projection screens, one or more diffraction elements, and/or one or more filters between an observer 190 and the projection screen 160, between any two display screens 130-160, and/or the display screen 130 and the light source 120.

The display system 100 may include a touch sensitive display surface 135 provided in front of or as part of the front display 130. A processing system may be configured to detect whether a touch input is performed to a portion of the front display displaying the one or more objects, and/or display content based on the touch input(s).

One or more of the display screens 130-160 may be in-plane switching mode liquid crystal display devices (IPS-LCDs). The IPS-LCD may be a crossed polarizer type with a polarizer on one side of the cells being perpendicular to a polarizer on an opposite side of the cells (i.e., transmission directions of the polarizers are placed at right angles). In one embodiment, a pair of crossed polarized layers may be provided with a first polarizer layer provided in front of the display screen 130 and a second polarizer layer provided behind the display screen 160.

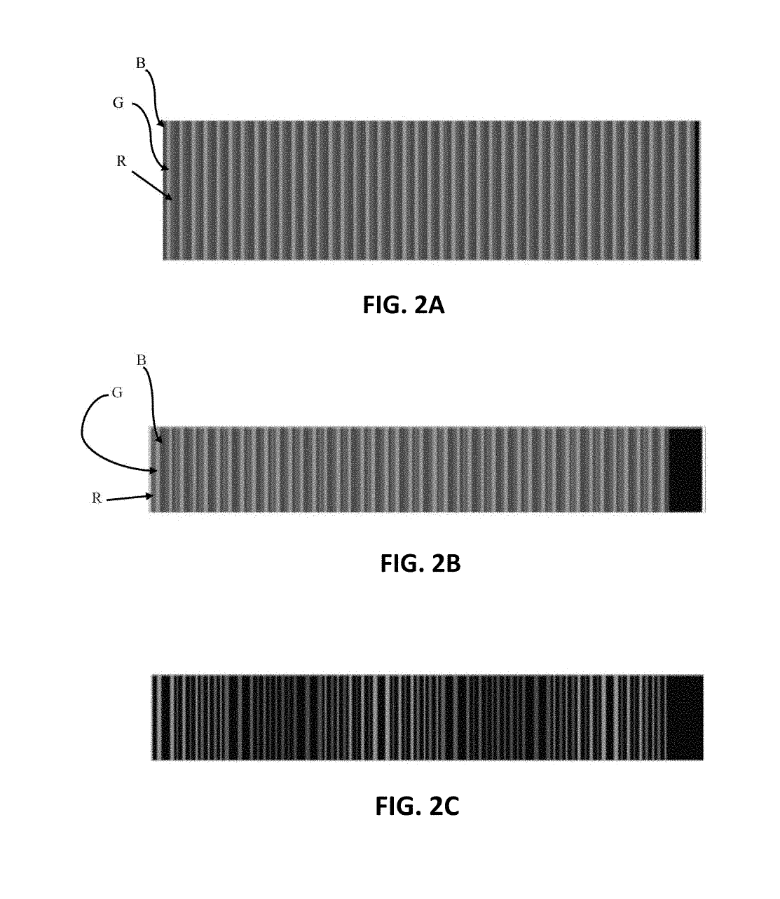

FIGS. 2A-C illustrate an arrangement in an MLD system which experiences moire interference. FIG. 2A is a top plan view of color filters/pixels of a first liquid crystal display (LCD) where pixels or subpixels are the same color in each column. In particular, FIG. 2A shows a LCD having a conventional red-green-blue (R-G-B) repeating pattern or arrangement, wherein the pixels or subpixels are the same color in each column. Starting from the left side of FIG. 2A, the color filter stripes are arranged in vertical lines in a BGR order, and this BGR order repeats itself over and over moving from left to right across the display of FIG. 2A. Thus, the pattern in the display or display layer of FIG. 2A includes blue columns, green columns, and red columns. The green (G) columns are located between blue (B) and red (R) colored columns. A subpixel may be considered the area of a given pixel electrode in an area of a particular color filter. For instance, R, G and B subpixels may make up a pixel. Alternatively, a subpixel may be considered to be a pixel. FIG. 2A is shown without color mask rotation. Conventionally, both panels of a multiple layered display (MLD) may be configured similarly with such an R-G-B arrangement. The repeatable pattern may be R-G-B, or R-B-G, or any other combination.

Likewise, FIG. 2B is a top plan view of color filters/pixels/subpixels of a second LCD where pixels or subpixels are also the same color in each column. Starting from the left side of FIG. 2B, the color filter stripes are arranged in vertical lines in a RGB order, and this order repeats itself over and over moving from left to right across FIG. 2B. The repeatable pattern may be R-G-B, or R-B-G, or any other combination involving these colors. As shown in FIG. 2B, like in FIG. 2A, green (G) columns are located between blue (B) and red (R) colored columns.

FIG. 2C is a top plan view of a MLD system resulting from the combination of the LCDs of FIGS. 2A and 2B, one on top of the other in a stacked overlapping relationship in a MLD system. FIG. 2C shows the mixing of the color filter and pixel/subpixel patterns shown in FIGS. 2A and 2B. In particular, FIG. 2C illustrates the emergence of moiré interference given an instance where both LCDs have a similar R-G-B column arrangement, where the pixels are the same color in each column. For example, when the FIG. 2B pattern overlaps the FIG. 2A pattern in a MLD system, green color filter lines overlap (e.g., see the left portion of FIG. 2C), and light in this green filter line overlap area is transmitted through the MLD system making for a comparatively bright green patch. When a green filter overlaps a red filter for instance (or a blue filter is over a red filter), not as much light will be transmitted making for a dark region (e.g., see the dark regions surrounding the green stripe at the left side of FIG. 2C). Since the rear and front displays or display layers have slightly different sizes when projected onto a retina, the pixels will slowly change from being in phase to out of phase. This has the effect of producing dark and bright bands otherwise known as moire interference.

Embodiments of this invention address, and reduce or solve, this moire interference problem in display systems including a plurality of displays. Certain example embodiments of the instant invention provide solution(s) that make moiré interference in MLD systems vanish or substantially vanish, but without significantly sacrificing the rear display resolution and contrast.

On approach to minimize visible moiré interference is to rotate panels of an MLD with respect to each other. For example, the panels may be rotated with respect to each other at 45 degrees. In U.S. Pat. No. 6,906,762, it is proposed to reduce the interference by using a stripe pixel pattern on one screen and a 45 degree diagonal pixel pattern on another screen. Tests in lab have shown that rotating panels with respect to each other at 45 degrees minimizes visible moiré interference. This is because rotating one display at 45 degrees to a second display changes the orientation and pitch of the interference to a below visible threshold.

One means of implementing this in an MLD would be to turn the entire display system, however this can be cumbersome from a mechanical point of view since the form factor is increased by as much as 1.4× the longest side of the display and requires increased cable lengths etc. Given space constraints within certain applications (e.g., vehicular systems) this approach may be impractical.

Another solution to minimize visible moiré interference, is to rotate the pixels and redo the address routing, however this may be difficult and require multiple tracks per subpixel which would reduce precious pixel active area.

The largest contribution to moiré interference on colour displays is the colour pixel patterns since these form successive bright and dark nodes for each common colour combination, for example green-green. These three colour combinations then add separately to give intense interference.

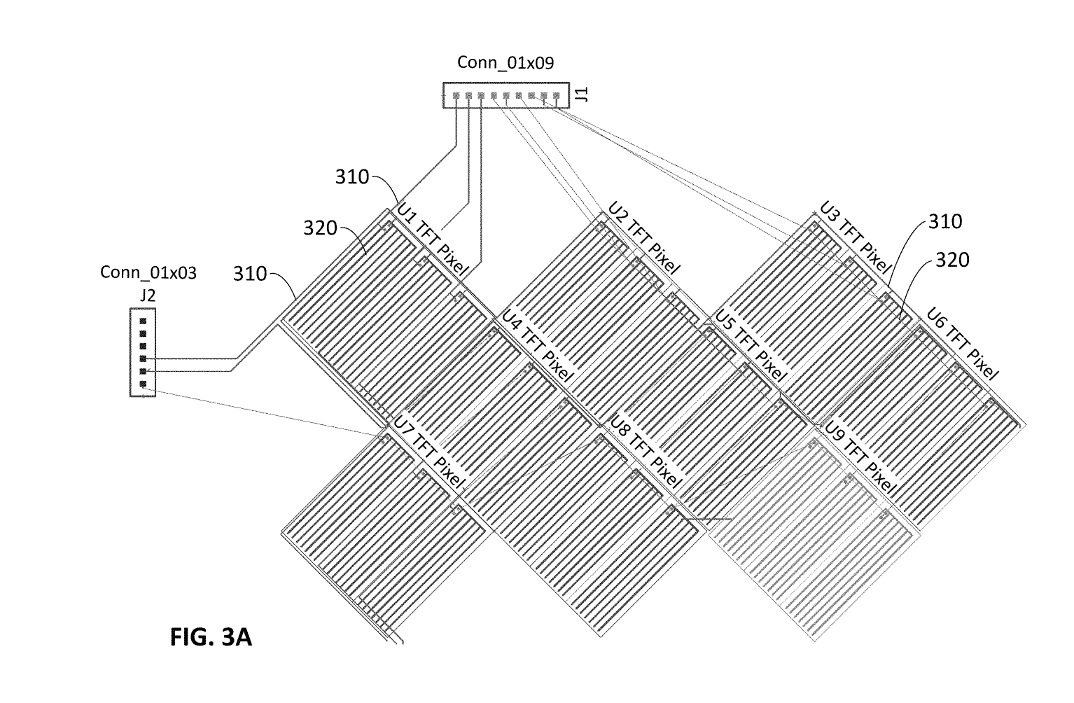

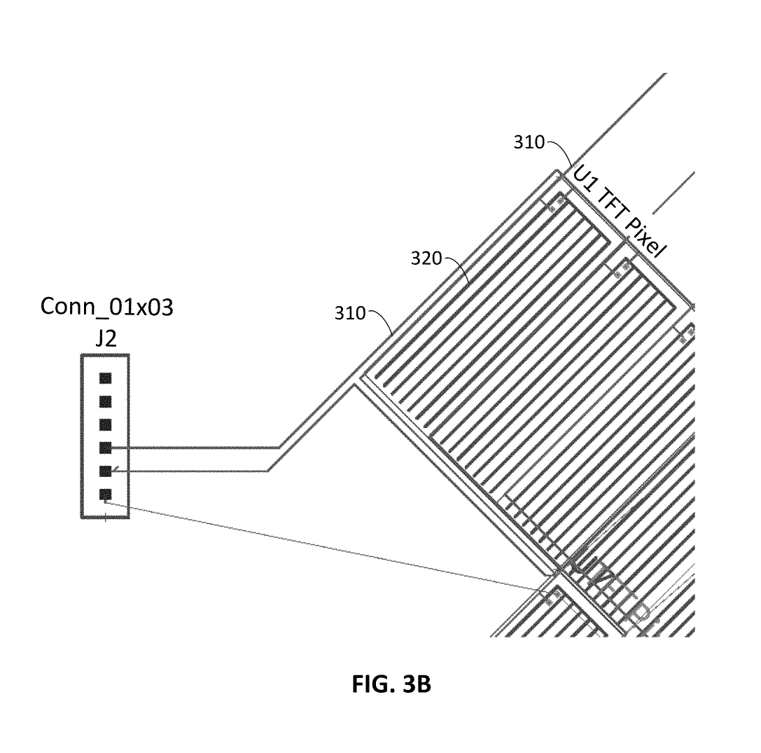

FIGS. 3A and 3B illustrate an exemplary layout of pixels with both the addressing matrix 310 and pixel electrodes 320 rotated such that they are provided at the same angle (e.g., at 45 degrees). FIG. 3B illustrated an enlarged view of a portion of FIG. 3A. The embodiment shown in FIGS. 3A and 3B may be provided as one of the displays in an MLD, with one or more other displays having pixel electrodes that are rotated to the configuration illustrated in FIGS. 3A and 3B. In this configuration, the colour filters of the respective subpixels are rotated at the same angle with the addressing matrix 310. In FIGS. 3A and 3B, the tracks 310 route signals from a data driver and/or a gate driver for driving electrodes 320 (e.g., IPS electrodes on a TFT layer). As illustrated by FIGS. 3A and 3B, the routing of the tracks can become complicated with both the addressing matrix and colour filters being provided at the same angle. In addition, multiple tracks of the addressing matrix 310 are provided parallel to each other. As illustrated in FIGS. 3A and 3B, four parallel track runs may be needed in some portions of the display.

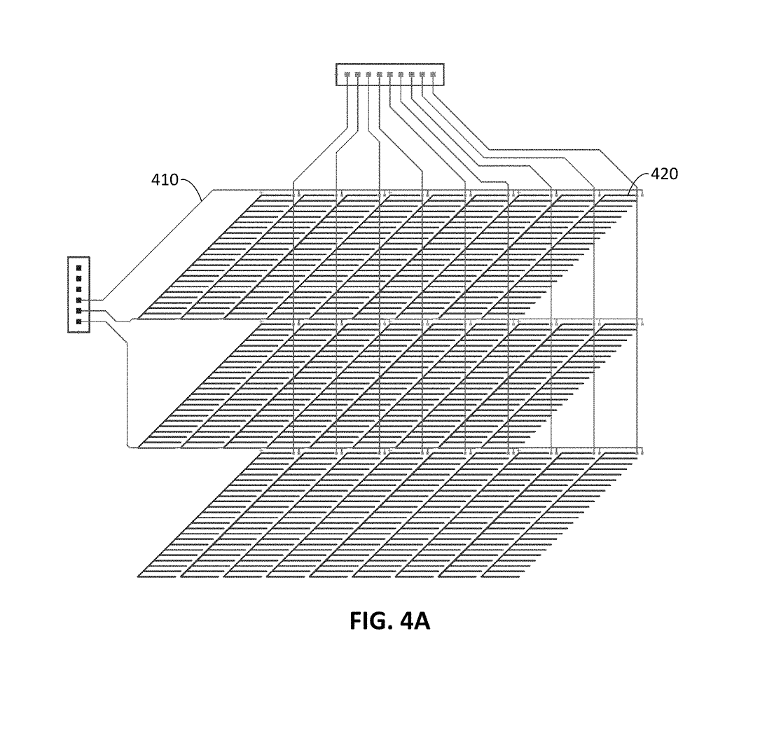

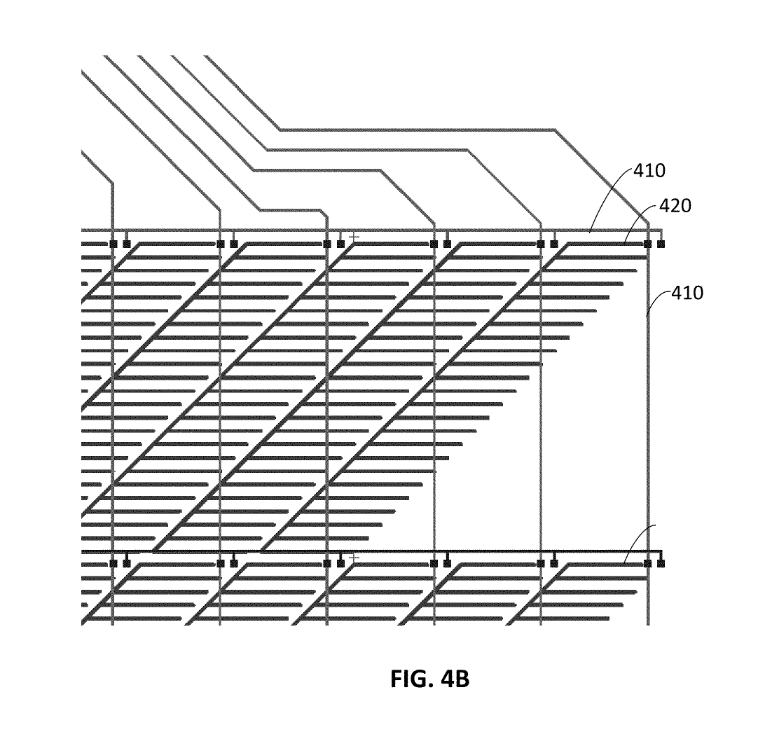

To reduce moire interference and overcome one or more of these disadvantages, the addressing matrix in a display may be provided at a different angle relative to the electrodes and/or the colour filters of the display. FIGS. 4A and 4B illustrate an exemplary embodiment with the subpixels addressing matrix 410 which is rotated with respect to the pixel electrodes 420 (e.g., IPS electrodes on a TFT layer) in the same display panel. FIG. 4B illustrated an enlarged view of a portion of FIG. 4A. While the row and column tracks 410 may overlap the electrodes, because the row and column tracks are thin, the contribution to moire interference in the horizontal and vertical directions may be minimal.

In FIGS. 4A and 4B, each 45 degree stripe going from bottom left to top right can be one color (e.g., R, G, B, or W subpixel). The embodiment shown in FIGS. 4A and 4B may be provided as one of the displays in an MLD, with one or more other displays having pixel electrodes that are rotated with reference to the configuration illustrated in FIGS. 4A and 4B. The MLD with this configuration may have addressing matrix in one display that is the same (e.g., arranged in the same orientation) as addressing matrix in another display, while the pixels in one display may be rotated with reference to pixels in the other display.

In this embodiment, the addressing matrix 410 is laid out in a standard fashion (e.g., according to the manner in the other displays), while the pixel electrodes 420 and colour filter matrix are provided at an angle (e.g., 45 degrees) to the pixel electrodes in the other displays and/or the addressing matrix 410. The configuration illustrated in FIG. 4, is much easier to route than the configuration illustrated in FIG. 3, thus improving transmission. Accordingly, moire interference can be reduced without incurring the transmission and complexity costs imposed by the complex layout.

In some exemplary embodiments, all of the subpixels in one display panel may be rotated in the same direction which is different from a direction in which all of the subpixels are oriented in another display panel. In one embodiment, pixels in adjacent display panels may be rotated with respect to pixels in another display. Pixels in display panels that are not adjacent to each other may have the same orientation.

In some exemplary embodiments only the colour filter are rotated and the addressing matrix may remain the same (e.g., as in the other displays of the MLD). Accordingly, in some embodiments, the addressing matrix in different displays layers may overlap each other while the color filters in one display are rotated with respect to pixels in another display. The pixel electrodes and/or the common electrode may be transparent electrodes formed of, e.g., indium tin oxide (ITO), so that the contribution to moire interference is minimal In some embodiments, the electrodes may be provided on the same glass layer as the transistors and the tracks, but may be electrically separated by an oxide layer.

In the configuration of FIGS. 4A and 4B, the row and column track placement may be configured in a standard rectilinear format with one row line per pixel and one column line per subpixel. As other displays of the MLD, the row lines may drive the base of a transistor which charges a capacitor to the voltage applied on the column lines. The IPS electrodes may be at the same potential as the capacitor after the charging.

The shape of the subpixels in the displays may have a square, rectangular, oblong or other shape. In some examples, the shape of one colour subpixel may be different from the shape of one or more other colour subpixel in the same display.

While the discussion above is made with reference to the subpixels being rotated 45 degrees, the amount of rotation is not so limited. In some examples, the rotation of the subpixels may be greater of less than 45 degrees.

In some embodiments, the subpixel repeating patter of the RGB and RGBW subpixels may include multiple subpixels of the same colour. For example, a repeating group of subpixels may include R, G, B, G repeating pattern. In some examples, the repeating group may be followed by a mirror image of the repeating group.

In some example, one or more displays may include a chevron pixel layout. The wide viewing angle normally obtained with a chevron pixel layout may not be necessary in all applications using an MLD, such as in portable applications or automotive systems.

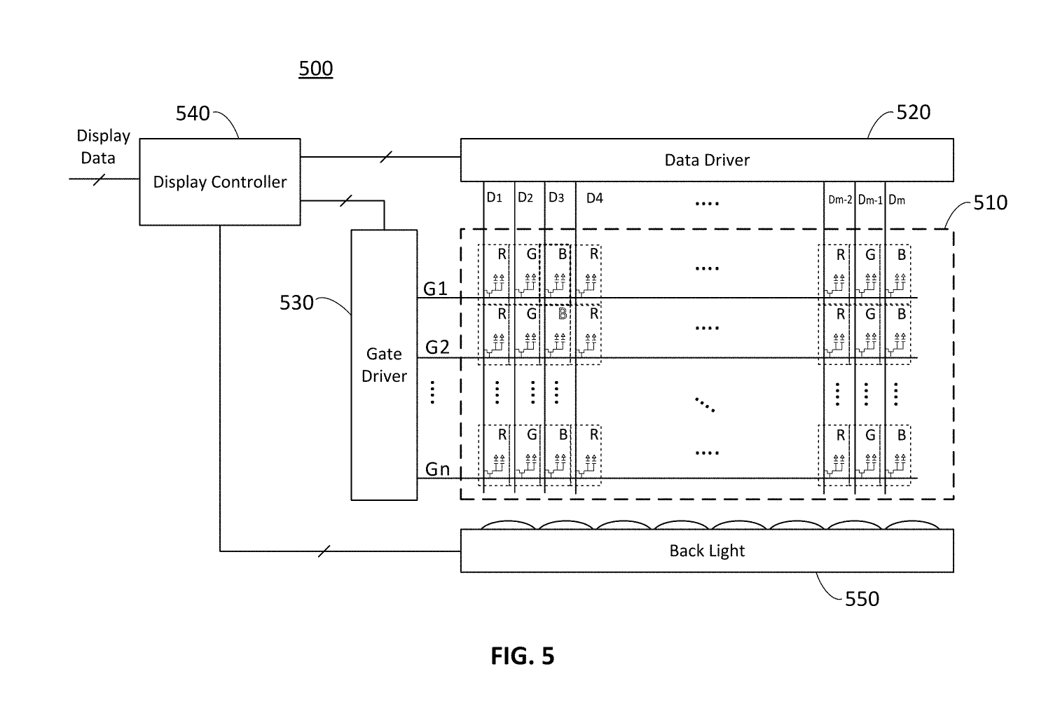

FIG. 5 illustrates an exemplary embodiment of control system 500 for a display including RGB sub-pixel configuration. The exemplary system 500 may be provided for one or more of the displays in an MLD. While the control system 500 is including RGB sub-pixel configuration, it is not so limited and may include active and/or passive white (W) sub-pixels.

The system 500 includes a display panel 510 comprising sub pixels including active red (R), active green (G), active blue (B) sub-pixels. The sub-pixels are arranged in a matrix configuration. The red (R), green (G), and blue (B) sub-pixels have corresponding color filters. A white (W) sub-pixel may have no color filter. The respective sub-pixels may have the same size ratio. The sub-pixels are illustrated having a repeating RGB configuration but are not so limited.

As illustrated in FIG. 5, each of the active sub-pixels includes an associated transistor (e.g., a thin film transistor) coupled to respective data lines D1-Dm and gate lines G1-Gn. Passive white (W) sub-pixels (not illustrated) may include pre-aligned liquid crystal molecules and may not have associated transistors or electrode structures. The transistors may be formed in the respective regions of the active sub-pixels defined by n gate lines G1-Gn and m data lines Dl-Dm. The liquid crystal cells of the active sub-pixels are connected with the respective transistors. The respective transistor is provided a data signal via one of the data lines (e.g., data line D1) in response to a scan pulse provided by the respective gate line (e.g., gate line G1). In FIG. 5, the liquid crystal cell of the sub-pixel is represented with an LCD capacitor corresponding to a common electrode and a sub-pixel electrode connected to the transistor. A storage capacitor is provided in the active sub-pixel configured to maintain the data signal charge on the LCD capacitor until the next data signal is received.

A data driver 520 is configured to supply signals to RGB sub-pixels via the data lines D1-Dm. A gate driver 530 is configured to supply a scan pulse to RGB sub-pixels via the gate lines G1-Gn. A display controller 540 is configured to receive display data (e.g., from a Graphics Processing Unit) and control operation of the data driver 520 and gate driver 530. The display data may include input image signals R, G, and B and input control signals for controlling the display of the input image signals. The input control signals may include a vertical synchronizing signal VSYNC, a horizontal synchronizing signal HSYNC, a main clock MCLK, and/or a data enable signal DE. Based on the received display data, the display controller 540 may generate data control signals form the data driver and gate control signals for the gate driver. Based on the received display data, the display controller 540 may also control the operation of the back light 550. The display controller 540 may be configured to individually control a plurality of light sources provided in the back light 550.

A single display 510 is illustrated in FIG. 5. In some exemplary embodiments, the MLD may include a plurality of display panels arranged in a substantially parallel manner. Each of the display panels may include its own associated gate driver and data driver. In some embodiments, the display controller 540 may be configured to provide control signals to a plurality of gate driver and data drivers. Alternatively, a dedicated display controller may be provided for each of the display panels.

As discussed above, the plurality of display panels may be arranged in a substantially parallel manner, with a front display panels overlapping one or more display panels. One or more of the display panels may have sub-pixels that are rotated with respect to sub-pixels in other display panels. The data lines D1-Dm and the gate lines G1-Gn on each display panel of the MLD may be provided with the same orientation to each other (e.g., in a rectilinear configuration).

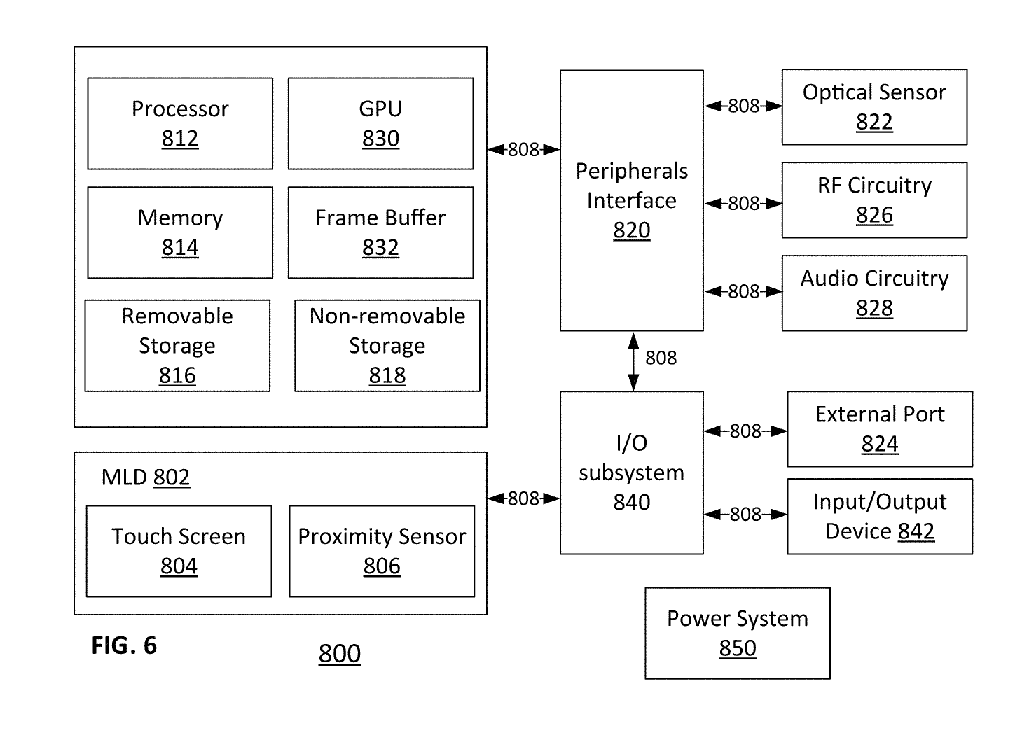

FIG. 6 illustrates an exemplary system 800 upon which embodiments of the present disclosure(s) may be implemented. The system 800 may be a portable electronic device that is commonly housed, but is not so limited. The system 800 may include a multi-layer display 802 including a plurality of overlapping displays. The multi-layer system may include a touch screen 804 and/or a proximity detector 806. The various components in the system 800 may be coupled to each other and/or to a processing system by one or more communication buses or signal lines 808.

The multi-layer display 802 may be coupled to a processing system including one or more processors 812 and memory 814. The processor 812 may comprise a central processing unit (CPU) or other type of processor. Depending on the configuration and/or type of computer system environment, the memory 814 may comprise volatile memory (e.g., RAM), non-volatile memory (e.g., ROM, flash memory, etc.), or some combination of the two. Additionally, memory 814 may be removable, non-removable, etc.

In other embodiments, the processing system may comprise additional storage (e.g., removable storage 816, non-removable storage 818, etc.). Removable storage 816 and/or non-removable storage 818 may comprise volatile memory, non-volatile memory, or any combination thereof. Additionally, removable storage 816 and/or non-removable storage 818 may comprise CD-ROM, digital versatile disks (DVD) or other optical storage, magnetic cassettes, magnetic tape, magnetic disk storage or other magnetic storage devices, or any other medium which can be used to store information for access by processing system.

As illustrated in FIG. 8, the processing system may communicate with other systems, components, or devices via peripherals interface 820. Peripherals interface 820 may communicate with an optical sensor 822, external port 824, RC circuitry 826, audio circuitry 828 and/or other devices. The optical sensor 882 may be a CMOS or CCD image sensor. The RC circuitry 826 may be coupled to an antenna and allow communication with other devices, computers and/or servers using wireless and/or wired networks. The system 800 may support a variety of communications protocols, including code division multiple access (CDMA), Global System for Mobile Communications (GSM), Enhanced Data GSM Environment (EDGE), Wi-Fi (such as IEEE 802.11a, IEEE 802.11b, IEEE 802.11g and/or IEEE 802.11n), BLUETOOTH (BLUETOOTH is a registered trademark of Bluetooth Sig, Inc.), Wi-MAX, a protocol for email, instant messaging, and/or a short message service (SMS), or any other suitable communication protocol, including communication protocols not yet developed as of the filing date of this document. In an exemplary embodiment, the system 800 may be, at least in part, a mobile phone (e.g., a cellular telephone) or a tablet.

A graphics processor 830 may perform graphics/image processing operations on data stored in a frame buffer 832 or another memory of the processing system. Data stored in frame buffer 832 may be accessed, processed, and/or modified by components (e.g., graphics processor 830, processor 812, etc.) of the processing system and/or components of other systems/devices. Additionally, the data may be accessed (e.g., by graphics processor 830) and displayed on an output device coupled to the processing system. Accordingly, memory 814, removable 816, non-removable storage 818, frame buffer 832, or a combination thereof, may comprise instructions that when executed on a processor (e.g., 812, 830, etc.) implement a method of processing data (e.g., stored in frame buffer 832) for improved display quality on a display.

The memory 814 may include one or more applications. Examples of applications that may be stored in memory 814 include, navigation applications, telephone applications, email applications, text messaging or instant messaging applications, memo pad applications, address books or contact lists, calendars, picture taking and management applications, and music playing and management applications. The applications may include a web browser for rendering pages written in the Hypertext Markup Language (HTML), Wireless Markup Language (WML), or other languages suitable for composing webpages or other online content. The applications may include a program for browsing files stored in memory.

The memory 814 may include a contact point module (or a set of instructions), a closest link module (or a set of instructions), and a link information module (or a set of instructions). The contact point module may determine the centroid or some other reference point in a contact area formed by contact on the touch screen. The closest link module may determine a link that satisfies one or more predefined criteria with respect to a point in a contact area as determined by the contact point module. The link information module may retrieve and display information associated with selected content.

Each of the above identified modules and applications may correspond to a set of instructions for performing one or more functions described above. These modules (i.e., sets of instructions) need not be implemented as separate software programs, procedures or modules. The various modules and sub-modules may be rearranged and/or combined. Memory 814 may include additional modules and/or sub-modules, or fewer modules and/or sub-modules. Memory 814, therefore, may include a subset or a superset of the above identified modules and/or sub-modules. Various functions of the system may be implemented in hardware and/or in software, including in one or more signal processing and/or application specific integrated circuits.

Memory 814 may store an operating system, such as Darwin, RTXC, LINUX, UNIX, OS X, WINDOWS, or an embedded operating system such as VxWorks. The operating system may include procedures (or sets of instructions) for handling basic system services and for performing hardware dependent tasks. Memory 814 may also store communication procedures (or sets of instructions) in a communication module. The communication procedures may be used for communicating with one or more additional devices, one or more computers and/or one or more servers. The memory 814 may include a display module (or a set of instructions), a contact/motion module (or a set of instructions) to determine one or more points of contact and/or their movement, and a graphics module (or a set of instructions). The graphics module may support widgets, that is, modules or applications with embedded graphics. The widgets may be implemented using JavaScript, HTML, Adobe Flash, or other suitable computer program languages and technologies.

An I/O subsystem 840 may include a touch screen controller, a proximity controller and/or other input/output controller(s). The touch-screen controller may be coupled to a touch-sensitive screen or touch sensitive display system. The touch screen and touch screen controller may detect contact and any movement or break thereof using any of a plurality of touch sensitivity technologies now known or later developed, including but not limited to capacitive, resistive, infrared, and surface acoustic wave technologies, as well as other proximity sensor arrays or other elements for determining one or more points of contact with the touch-sensitive screen. A touch-sensitive display in some embodiments of the display system may be analogous to the multi-touch sensitive screens.

The other input/output controller(s) may be coupled to other input/control devices 842, such as one or more buttons. In some alternative embodiments, input controller(s) may be coupled to any (or none) of the following: a keyboard, infrared port, USB port, and/or a pointer device such as a mouse. The one or more buttons (not shown) may include an up/down button for volume control of the speaker and/or the microphone. The one or more buttons (not shown) may include a push button. The user may be able to customize a functionality of one or more of the buttons. The touch screen may be used to implement virtual or soft buttons and/or one or more keyboards.

In some embodiments, the system 800 may include circuitry for supporting a location determining capability, such as that provided by the Global Positioning System (GPS). The system 800 may include a power system 850 for powering the various components. The power system 850 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices. The system 800 may also include one or more external ports 824 for connecting the system 800 to other devices.

Portions of the present invention may be comprised of computer-readable and computer-executable instructions that reside, for example, in a processing system and which may be used as a part of a general purpose computer network (not shown). It is appreciated that processing system is merely exemplary. As such, the embodiment in this application can operate within a number of different systems including, but not limited to, general-purpose computer systems, embedded computer systems, laptop computer systems, hand-held computer systems, portable computer systems, stand-alone computer systems, game consoles, gaming systems or machines (e.g., found in a casino or other gaming establishment), or online gaming systems.

The exemplary embodiments of the present disclosure provide the invention(s), including the best mode, and also to enable a person skilled in the art to practice the invention, including making and using any devices or systems and performing any incorporated methods. While specific exemplary embodiments of the present invention(s) are disclosed herein, it should be understood that modifications, substitutions and alternatives may be apparent to one of ordinary skill in the art and can be made without departing from the scope of this

1. An instrument panel comprising:
a multi-layer display including a first display panel and a second display panel arranged in a substantially parallel manner, the second display panel overlapping the first display panel, the first display panel including a first array of pixels and a first addressing matrix for driving the first array of pixels, the second display panel including a second array of pixels that are rotated with reference to the first array of pixels and a second addressing matrix for driving the second array of pixels, the first addressing matrix and the second addressing being arranged in the same direction with respect to each other;
a backlight configured to provide light to the first display panel and the second display panel; and
a processing system comprising at least one processor and memory, the processing system configured to simultaneously display content on the first display panel and content on the second display panel.

2. The instrument panel of claim 1, wherein colour filters in the first display panel are rotated with reference to colour filter in the second display panel.

3. The instrument panel of claim 1, wherein electrodes of the first array of pixels and/or the second array of pixels are transparent electrodes.

4. The instrument panel of claim 1, wherein electrodes of the first array of pixels or the second array of pixels are provided on the same glass layer as pixel transistors and the respective first addressing matrix or second addressing matrix.

5. The instrument panel of claim 1, wherein the row and column track placement of the first addressing matrix and the second addressing matrix is in a rectilinear format with one row line per pixel and one column line per subpixel.

6. A multi-layered display comprising:
a first screen configured to display a first image and having a first pixel alignment and a first addressing matrix alignment for driving the pixels in the first screen; and
a second screen configured to display a second image and having a second pixel alignment and a second addressing matrix alignment for driving the pixels in the second screen, wherein the first screen is in front of the second screen,
wherein the second pixel alignment is 45 degrees with respect to the first pixel alignment and the first addressing matrix alignment corresponds to the second addressing matrix alignment.

7. The multi-layered display of claim 6, wherein the first screen is a selectively transparent foreground screen capable of displaying a foreground image and the second screen is a background screen capable of displaying a background image.

8. The multi-layered display of claim 6, wherein the first addressing matrix substantially overlaps the second addressing matrix.

9. The multi-layered display of claim 6, wherein pixel electrodes in the first screen and the second screen are transparent electrodes.

10. The instrument panel of claim 1, wherein the row and column track placement of the first addressing matrix and the second addressing matrix is in a rectilinear format with one row line per pixel and one column line per subpixel.

11. A multi-layered display comprising:
a first screen configured to display first content and including a first addressing matrix alignment for driving pixels in the first screen; and
a second screen, arranged in a substantially parallel manner with the first screen, configured to display second content, and including a second addressing matrix alignment for driving pixels in the second screen,
wherein colour filters of sub-pixels in the first screen are rotated with reference to colour filters of sub-pixels in the second screen, and row and column tracks of the first addressing matrix and the second addressing matrix are arranged in a rectilinear configuration.

12. The multi-layered display of claim 11, wherein the first screen is a touch sensitive display, and further includes a processing system configured to detect whether a touch input is performed to a portion of the first screen displaying the content.

13. The multi-layered display of claim 11, wherein pixel electrodes of the first screen and/or pixel electrodes of the second screen are transparent electrodes.

14. The multi-layered display of claim 11, wherein pixel electrodes of the first screen or second screen are provided on the same glass layer as sub-pixel transistors and the respective first addressing matrix or second addressing matrix.

15. The multi-layered display of claim 11, wherein the colour filters of sub-pixels in the first screen are rotated 45 degrees with reference to colour filters of sub-pixels in the second screen.

16. The multi-layered display of claim 11, wherein the row and column tracks of the first addressing matrix overlap the row and column tracks of the second addressing matrix.

17. An instrument panel comprising;
a multi-layer display including a front display panel and a rear display panel arranged in a substantially parallel manner, the front display panel overlapping the rear display panel, the front display panel and the rear display panel including an array of pixels, each pixel including red (R), green (G), and blue (B) sub-pixels, wherein the red (R), green (G), and blue (B) sub-pixels of the front display panel are rotated with reference to the red (R), green (G), and blue (B) sub-pixels of the rear display panel;
the multi-layer display further comprising a pair of crossed polarized layers, a first polarized layer of the pair of crossed polarized layers provided in front of and adjacent to the front display panel and a second polarized layer of the pair of crossed polarized layers provided behind and adjacent to the rear display panel;
a first data driver configured to control the red (R), green (G), and blue (B) sub-pixels of the front display panel and a first gate driver configured to provide scan pulses to the red (R), green (G), and blue (B) sub-pixels of the front display panel, wherein the first data driver and the first gate driver transmit signals via a first set of row and column tracks;
a second data driver configured to control the red (R), green (G), and blue (B) sub-pixels of the rear display panel and a second gate driver configured to provide scan pulses to the red (R), green (G), and blue (B) sub-pixels of the rear display panel, wherein the second data driver and the second gate driver transmit signals via a second set of row and column tracks that are arranged in a substantially parallel manner to the first set of row and column tracks; and
a backlight configured to provide light to the front display panel and the rear display panel of the multi-layer display; and
a processing system comprising at least one processor and memory, the processing system configured to:
control the front display panel to display first content; and
control the rear display panel to display second content.

18. The instrument panel of claim 17, wherein the first set of row and column tracks and the second set of row and column tracks are arranged in a rectilinear configuration with one row line per pixel and one column line per sub-pixel.

19. The instrument panel of claim 17, wherein the red (R), green (G), and blue (B) sub-pixels of the front display panel are rotated 45 degrees with reference to the red (R), green (G), and blue (B) sub-pixels of the rear display panel.

20. The instrument panel of claim 17, wherein sub-pixel electrodes of the front display panel and the rear display panel are transparent electrodes.
